(19) United States
(12) Patent Application Publication
(10) Pub. No.: US 2025/0124383 A1
(43) Pub. Date: Apr. 17, 2025

(54) RISK ASSESSMENT SYSTEM

(71) Applicant: Kenvue Brands LLC, Summit, NJ (US)

(72) Inventors: David Merritt, Monument, CO (US); Karl DSouza, Reading (GB); Jeffrey Peyton Hallenbeck, Summit, NJ (US); Daniel A. Jalosinski, Perkasie, PA (US); Patrick Tendick, Basking Ridge, NJ (US); Christopher J. van Schijndel, Doylestown, PA (US)

(21) Appl. No.: 18/910,170

(22) Filed: Oct. 9, 2024

Related U.S. Application Data
(60) Provisional application No. 63/544,308, filed on Oct. 16, 2023.

(51) Int. Cl. G06Q 10/0635

(52) U.S. Cl. CPC G06Q 10/0635

(57) ABSTRACT

Systems and methods for assessing enterprise-level risk assessment of a supplier. The method includes receiving an indication of a supplier, generating an impact score for the supplier; generating a likelihood score for the supplier; generating a combined risk score based on the generated impact score and the generated likelihood score; evaluating the generated combined risk score relative to a dynamic risk threshold; and based on the evaluation, generating an output including the generated combined risk score.

### CROSS-REFERENCE TO RELATED APPLICATIONS

This application claims the benefit of U.S. Provisional Application No. 63/544,308 filed Oct. 16, 2023, the contents of which is incorporated herein by reference in its entirety.

### BACKGROUND

Organizations assess suppliers for goods and services to determine the risk of using, or not using, the supplier to provide goods and/or services. Risk assessments may include cyber risk assessments, operational risk assessments, financial risk assessments, and so forth. Risk assessments assess both the impact that an event would have on the organization and well as the likelihood of an event occurring. The risks are typically manually derived, categorical or numerical, and not well-tailored to an organization. The predicted risks are evaluated at the organizational level and characterize the potential of an organization's losses due to adverse events or activities affecting one or more of the following aspects of organizational health: operational, financial, cybersecurity, compliance, regulatory, health and safety, supply chain, operational technology, enterprise technology, social, and environmental. Risk assessments must meet several requirements, including being scalable, accurate, consistent, reliable, and tailorable to the organization's goals, priorities, and risk tolerances. Risk assessments must also be flexible and extensible enough to account for potential changes in the organization's goals, priorities, and risk tolerances.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one example, a computer-implemented method is provided. The method includes receiving an indication of a supplier; generating an impact score for the supplier; generating a likelihood score for the supplier; generating a combined risk score based on the generated impact score and the generated likelihood score; evaluating the generated combined risk score relative to a dynamic risk threshold; and based on the evaluation, generating an output including the generated combined risk score.

In another example, a system is provided. The system includes a memory; and a processor coupled to the memory configured to: receive an indication of a supplier; generate an impact score for the supplier; generate a likelihood score for the supplier, the generated likelihood score indicating a likelihood the new supplier will be a victim of one or more of a cyber-attack or an operational failure; generate a combined risk score based on the generated impact score and the generated likelihood score, the generated combined risk score indicating an overall risk of the supplier based on an impact of the supplier and the generated likelihood score; evaluate the generated combined risk score relative to a dynamic risk threshold; and based on the evaluation, generate an output including the generated combined risk score.

In another example, a computer-readable storage media is provided. The computer-readable storage media stores instructions that, when executed by a processor, cause the processor to receive an indication of a supplier; generate an impact score for the supplier; generate a likelihood score for the supplier, the generated likelihood score indicating a likelihood the new supplier will be a victim of one or more of a cyber-attack or an operational failure; generate a combined risk score based on the generated impact score and the generated likelihood score, the generated combined risk score indicating an overall risk of the supplier based on an impact of the supplier and the generated likelihood score; based on the generated combined risk score being greater than a dynamic risk threshold, triggering a questionnaire to be transmitted to the supplier; based on a response received from the supplier in response to the transmitted questionnaire, updating the combined risk score; and based on the updated combined risk score, generating an output including the combined risk score. Other technical features may be readily apparent to one skilled in the art from the following figures, descriptions, and claims.

### BRIEF DESCRIPTION OF THE DRAWINGS

The present description will be better understood from the following detailed description read in light of the accompanying drawings, wherein:

FIG. 1 illustrates an example system for assessing risk of a supplier or vendor;

FIG. 2 illustrates an example of current state challenges for assessing risk;

FIG. 3 illustrates a system for generating an output of a risk assessment;

FIG. 4 illustrates an example computer-implemented method of generating an output of a risk assessment;

FIGS. 5A-5B illustrate an example computer-implemented method of generating an output of a risk assessment; and

FIG. 6 is a block diagram illustrating an example computing environment suitable for implementing one or more of the various examples disclosed herein.

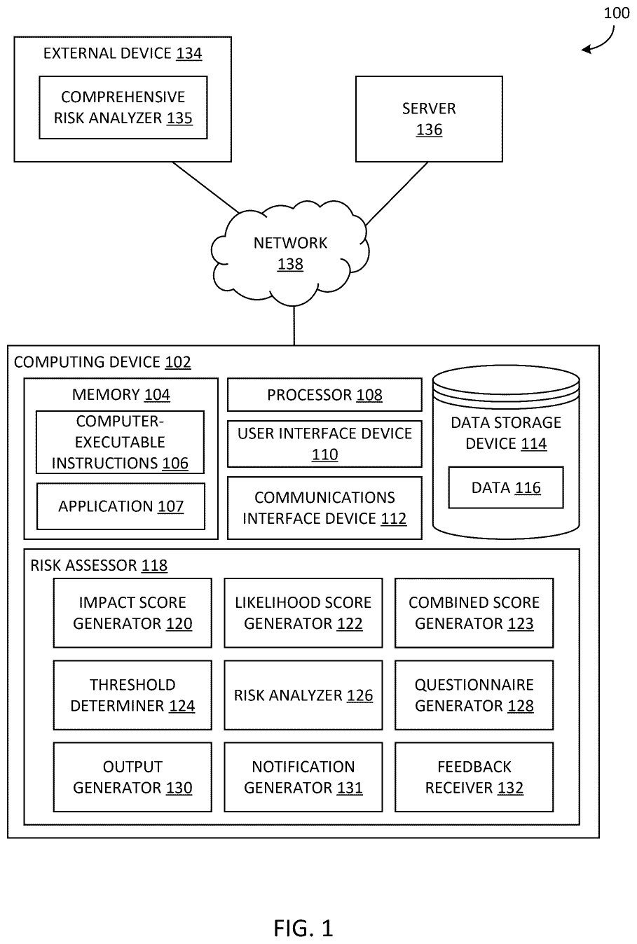

Corresponding reference characters indicate corresponding parts throughout the drawings. In FIGS. 1 to 6, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, for each supplier that an organization onboards or considers onboarding, a risk assessment is performed in order to assess both the impact that an event would have on the organization and well as the likelihood of an event occurring. However, particularly in organizations that contract with hundreds or thousands of different suppliers, performing thorough risk assessments on each and every potential supplier is impractical or even impossible due to the rigor of performing each assessment and the volume of assessments to be completed. For example, each risk assessment must be tailored to a particular organization's goals, priorities, and risk tolerances and be flexible and extensible to account for changes in the organization's goals, priorities, and risk tolerances. The risk assessments need to be current and not susceptible to being outdated and therefore inaccurate. The assessments must also be reasonably affordable, relative to the size of the organization performing the assessments. The assessment system must include sufficient and appropriate automation to increase the efficiency and scalability of assessments without undue, overburdensome human involvement while also providing a mechanism to capture the guidance of human experts in tailoring its risk scoring weight/factors. Therefore, there is a need for systems and methods that perform risk assessment in a timely, scalable, and dynamic manner.

Various examples of the present disclosure recognize and take into account these challenges and provide risk assessment systems and methods that, for a particular supplier purporting to provide goods or services to a particular organization, predict the impact of an event, a likelihood of an event, and an overall risk score for the supplier. The method includes generating an impact score for the supplier, generating a likelihood score for the supplier, generating a combined risk score based on the impact score and likelihood score, evaluating the combined risk score relative to a dynamic threshold, and, based on the evaluation, generating an output including the combined risk score. Thus, various examples of the present disclosure provide a risk assessment system designed in such a manner as to allow for its inclusion as a bi-directional component in a larger, comprehensive enterprise risk quantification system. Outputs from the risk assessment system are structured appropriately to be fed into an enterprise risk quantification system, which then outputs goals, priorities, and risk tolerances to be used by the risk assessment system. This allows the risk assessment system to be automatically tailored to an organization's goals, priorities, and risk tolerances without undue human involvement.

Various examples of the present disclosure provide a risk assessment system that operates in an unconventional manner by implementing multiple predictive models that operate in conjunction to determine how impactful a supplier is to the organization, determine the likelihood of a risk event, generate a combined risk score for the supplier, and determine a dynamic risk threshold for the supplier. The combined risk score is analyzed in view of the dynamic risk threshold to paint a comprehensive picture of risk for the supplier in order to evaluate and balance the risks and opportunities for partnering with the supplier. Additionally, the predictive models use dynamic risk thresholds based on various supplier-focused dynamics as circumstances change, including changes with the supplier, money being sent to the supplier, whether an actual compromise is discovered at the supplier, any change in engagement with the supplier, such as whether the supplier is now receiving more data or more sensitive data, whether a potential alternative supplier has been lost or added, and so forth. Furthermore, the predictive models use dynamic risk thresholds based on various organization-focused dynamics as circumstances change, including changes to the organization's goals, priorities, risk tolerances, and so forth.

The systems and methods described herein provide a technical solution to the inherently technical problem of performing risk assessments of technical suppliers at scale, including generating of new data structures to store and present supplier and organization risk data, reducing the burden of human input or otherwise human interaction from the traditional risk assessment process, and reducing the consumption of computing resources by identifying existing suppliers and performing a streamlined, efficient analysis that identifies updates to the supplier dynamics and the organization dynamics and generates updated risk scores accordingly. In particular, the various examples described herein describe performing a preliminary analysis of each potential new supplier, storing an initial risk score, and continuously monitoring a supplier for which the risk score is above a dynamic risk threshold for events that may change the risk score. In the event an event occurs, the risk score is updated from the initial risk score and re-evaluated based on the change to the risk score, as opposed to generating a new risk score each time a supplier is identified for analysis, reducing the burden of computing resources in evaluating the risk of a supplier or potential supplier.

FIG. 1 illustrates an example system for assessing risk of a supplier or vendor. The system 100 illustrated in FIG. 1 is provided for illustration only. Other examples of the system 100 can be used without departing from the scope of the present disclosure. In some examples, the system 100 generates a risk assessment of a supplier or vendor, including but not limited to a cyber risk assessment.

The system 100 includes a computing device 102, an external device 134, a server 136, and a network 138. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

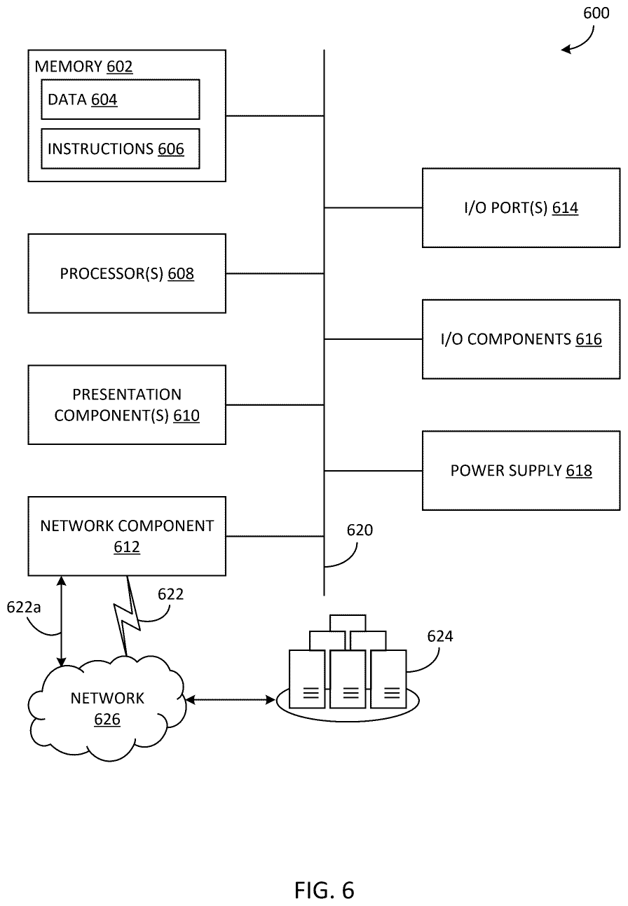

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIG. 6. In various examples, the processor 108 is configured to execute computer-executable instructions of the risk assessor 118 as described herein.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 can include both a memory component internal to the computing device 102 and a memory component external to the computing device 102, such as the server 136. The memory 104 stores data, such as one or more applications 107. The applications 107, when executed by the processor 108, operate to perform various functions on the computing device 102. The applications 107 can communicate with counterpart applications or services, such as web services accessible via the network 138. In an example, the applications 107 represent server-side services of an application executing in a cloud, such as a cloud server 136. In some examples, the application 107 is an application for assessing risk of a supplier or vendor and generating a risk assessment score for the supplier or vendor.

The user interface device 110 includes a graphics card for displaying data to a user and receiving data from the user. The user interface device 110 can also include computer-executable instructions, for example a driver, for operating the graphics card. Further, the user interface device 110 can include a display, for example a touch screen display or natural user interface, and/or computer-executable instructions, for example a driver, for operating the display. The user interface device 110 can also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, such as but not limited to the user device 136, can occur using any protocol or mechanism over any wired or wireless connection.

The computing device 102 further includes a data storage device 114 for storing data 116. The data 116 includes, but is not limited to, a database storing impact scores associated with one or more suppliers or vendors, risk scores associated with one or more suppliers or vendors, and determined risk thresholds associated with one or more suppliers or vendors, one or more template questionnaires to be provided to a supplier or vendor, questionnaires that have been received from one or more suppliers or vendors and include responses to the questions contained in the questionnaires, and so forth. In some examples, the database further includes various data associated with the supplier or vendor, including but not limited to, spending data, i.e., the amount of money provided to the supplier or vendor in exchange for services, a supplier category, supplier quality data associated with the supplier, a data security classification for the supplier, cybersecurity vulnerability risk data of the supplier, and operational, financial, environmental, regulatory, or logistical risk data of the supplier. In some examples, the data is dynamically updated from authoritative data sources internal and/or external to the organization, such as an internal procurement database housing all invoice data for third parties, an internal supplier quality database housing product and manufacturing quality data for all supply chain third parties, an internal asset management database housing information technology metadata for assets hosted by third parties, an external cybersecurity monitoring database housing security risk data for all known companies with public-facing networked assets, an external supply chain intelligence database housing operational risk data for companies commonly found in global product supply chains, and so forth.

The data storage device 114 may include one or more different types of data storage devices, such as, for example, one or more rotating disks drives, one or more solid state drives (SSDs), and/or any other type of data storage device. The data storage device 114 in some non-limiting examples includes a redundant array of independent disks (RAID) array. In other examples, the data storage device 114 includes a database. The data storage device 114, in this example, is included within the computing device 102, attached to the computing device 102, plugged into the computing device 102, or otherwise associated with the computing device 102. In other examples, the data storage device 114 includes a remote data storage accessed by the computing device 102 via the network 138, such as the server 136 which may be a remote data storage device, a data storage in a remote data center, a cloud storage, and so forth.

The computing device 102 further includes a risk assessor 118. In some examples, the risk assessor 118 is an example of a specialized processor, or processing unit, implemented on the processor 108. The risk assessor 118 assesses a particular type of risk for a particular supplier, or vendor. The risk assessor 118 includes an impact score generator 120, a likelihood score generator 122, a combined score generator 123, a threshold determiner 124, a risk analyzer 126, a questionnaire generator 128, an output generator 130, a notification generator 131, and a feedback receiver 132. Each of the impact score generator 120, likelihood score generator 122, combined score generator 123, threshold determiner 124, risk analyzer 126, questionnaire generator 128, output generator 130, notification generator 131, and feedback receiver 132 is an individual example of a specialized processor, or processing unit, implemented on the risk assessor 118.

The risk assessor 118 assesses the particular type of risk for the particular supplier by generating an impact score via an impact score generator 120, generating a likelihood score via a likelihood score generator 122, generating a combined risk score via a combined score generator 123 for the supplier based on particular data inputs, identifying one or more risk thresholds for the supplier via a threshold determiner 124, and evaluating the generated combined risk score relative to the one or more risk thresholds. Where the generated combined risk score exceeds one of the risk thresholds, a risk analyzer 126 determines further analysis is needed, and a questionnaire is generated that is sent to the supplier. Based on the additional information received in response to the questionnaire, the risk analyzer 126 performs an additional analysis of the supplier. Where the generated combined risk score does not exceed one of the risk thresholds, or after the additional analysis of the supplier, an output generator 130 generates an output containing a risk assessment of the supplier. In some examples, the generated output triggers an automatic response, including but not limited to approval of the supplier, limited approval of the supplier, denial of the supplier, a notification generated by the notification generator 131 on the user interface device 110 indicating the generated output is available, one or more automatically-generated actions which reduce the risk of the supplier, such as automatically scheduling table top exercises or cybersecurity training meetings where the supplier shows the most risk, automatically adding high-risk third parties to the organization's risk register for visibility and subsequent action, automatically tuning relevant security controls to limit the scope of the supplier's access to sensitive data and systems, and so forth.

Upon an indication of a new supplier being received, the impact score generator 120 generates an initial impact score for the supplier. In some examples, the score is correlated with the size and power of the negative effect a supplier may potentially have on the organization operating the risk assessor 118. In some examples, the impact score generator 120 is an example of a machine learning (ML) or artificial intelligence (AI) model that generates the impact score based on multiple weighted variables, including but not limited to data 116 associated with the supplier such as spending data, a supplier category, supplier quality data associated with the supplier, a data security classification for the supplier, a supplier's predetermined criticality level, and concentration data. The predetermined criticality level is determined by the organization operating the risk assessor 118 and the concentration data characterizes sole suppliers and how many other suppliers can supply the same good or service. The spending data is an amount of money provided to the supplier or vendor in exchange for goods or services. A supplier category is a category defining the type of supplier, including but not limited to a chemical compound supplier, an artificial intelligence (AI) service supplier, information technology (IT) service supplier, human resources (HR) firm, law firm, logistics supplier, call center provider, and so forth. The supplier quality data is a criticality score that measures supply chain and manufacturing supplier site criticality, or importance, based on several factors, including but not limited to manufacturing quality and performance, regulatory compliance, operational risks, and so forth. The data security classification is a classification of how securely the supplier protects the company's sensitive data, such as intellectual property (IP) and personally identifiable information (PII). However, it should be understood these examples are provided for illustration only and should not be construed as limiting. Various examples of variables are possible, including but not limited to additional variables such as an amount or quality of alternative suppliers, the type of data that is being accessed by or provided to the supplier, how often the variables change and/or how dynamic the variables are, and so forth. It should be understood that because the data 116 is dynamically refreshed, the impact score generator dynamically and continuously updates its scoring output. Thus, in various examples of the present disclosure include continuous monitoring of an entity or supplier and dynamically and automatically adjusting the scoring output for the entity or supplier in real-time based on the updated data received, which in turn causes an automatic update to the risk score and profile of the entity or supplier.

The impact score generator 120 generates the initial impact score based at least in part on the weighted variables. For example, where the supplier category, supplier quality data, and data security classification are the same for two suppliers, a first supplier for which an organization has a greater spend will have a greater impact score than a second supplier for which the organization has a lesser spend. In some examples, the generated initial impact score is expressed as a numerical value, such as a value between 0 and 10, 0 and 100, and so forth, where 0 represents the lowest risk for the supplier and the greatest value, and 10, 100, etc., represents the greatest risk for the supplier. In other examples, the generated initial impact score is expressed as a categorical score, such as A, B, C, and so forth, where A represents a low risk of using the supplier. In other examples, the generated initial impact score is expressed as a color, such as green, yellow, or red, where green represents a low risk, yellow represents a medium risk, and red represents a high risk.

Upon an indication of a new supplier being received, the likelihood score generator 122 generates an initial likelihood score for the supplier, where the score is correlated with the likelihood that the supplier will be subject to an event that impacts the organization operating the risk assessor 118. In some examples, the likelihood score generator 122 is an example of an ML or AI model that generates the likelihood score based on multiple weighted variables, including but not limited to data 116 associated with the supplier such as cybersecurity risks due to known vulnerabilities, prior compromises, poor security practices, or operational risks due to financial, logistical, regulatory, governmental, social, criminal, or other environmental factors. In some examples, the event is a cyber-related event, such as a cyber-attack. In other examples, the event is operational, such as a failure by the supplier to deliver the goods or services to the organization. For example, if the supplier has been the victim of a cyber-attack in the past, the likelihood score will be greater than if the supplier has not been the victim of a cyber-attack in the past. As another example, if the supplier has been the victim of multiple cyber-attacks that put confidential information at risk, or a cyber-attack more recently, the likelihood score will be greater than if the supplier has been the victim of a single cyber-attack or a cyber-attack less recently, respectively. As another example, if the supplier is located in an area with geopolitical restrictions which interfere with the supplier's ability to manufacture or ship goods across national borders, then the likelihood score will be greater than if the supplier does not have geopolitical restrictions. Because the data 116 is dynamically refreshed, the likelihood score generator dynamically and continuously updates its scoring output as described herein.

The combined score generator 123 generates a combined risk score based on the generated initial impact score and the generated initial likelihood score. The combined risk score measures the overall risk of the supplier based on both the impact the supplier has, or will have, on the organization and the likelihood that the supplier will be subject to an event that impacts the organization. By generating the combined risk score based on both impact and likelihood, rather than one or the other, the risk assessor 118 takes into account the nuance between suppliers that have high impacts to the organization but may or may not have a high likelihood of risk, suppliers that have low impacts to the organization but may or may not have a high likelihood of risk, and each variation in between.

In some examples, the combined score generator 123 generates the combined risk score by retrieving a matrix stored as data 116 in the data storage device 114 and mapping the generated initial impact score and the generated initial likelihood score on the matrix. For example, a supplier having a high impact score and a high likelihood score will result in a high combined risk score indicating a high risk. Conversely, a supplier having a low impact score and a low likelihood score will result in a low combined risk score indicating a low risk. In some examples, the combined risk score is expressed as a numerical value, such as a value between 0 and 10, 0 and 100, and so forth, where 0 represents the lowest risk for the supplier and the greatest value, such as 10, 100, etc., represents the greatest risk for the supplier. In other examples, the combined risk score is expressed as a categorical score, such as A, B, C, and so forth, where A represents a low risk of using the supplier. In other examples, the combined risk score is expressed as a color, such as green, yellow, or red, where green represents a low risk, yellow represents a medium risk, and red represents a high risk. These examples are presented for illustration only and should not be construed as limiting.

The threshold determiner 124 determines one or more thresholds to be used as a threshold to analyze the risk expressed by the combined risk score. In some examples, the threshold determiner 124 determines a single threshold to be used. In other examples, the threshold determiner 124 determines more than one threshold to be used, such as two thresholds, a higher threshold and a lower threshold. In some examples, the determined one or more thresholds are dynamic. In other words, the determined one or more thresholds may change over time, even for the same supplier, depending on changes to factors including, but not limited to, a change in the risk tolerance, goals, or priorities of an organization or individual implementing the computing device 102, a focus on a different or specific type of supplier(s) or service(s), a time of year, a history with the supplier, and so forth. The threshold determiner 124 determines the one or more thresholds by implementing a ML or AI model that takes into account various factors, including the factors used to generate the combined risk score in addition to the risk tolerance, goals, or priorities of the organization or individual implementing the computing device 102, the type of supplier, a service being supplied by the supplier, the time of year, the history with the supplier, the availability of replacement suppliers for the service being supplied, the type of engagement with the supplier including but not limited to the type of data that will provided to and/or received from the supplier, whether a compromise has been identified at the supplier and if so, how recently, an amount of money that will be paid to the supplier for their service(s), and so forth. In some examples, these factors use the goals, priorities, and risk tolerance data 116 of an organization that are retrieved from an external enterprise risk quantification system, such as a comprehensive risk analyzer 135 implemented on an external device, such as the external device 134. Because the data 116 is dynamically refreshed, the threshold determiner dynamically and continuously updates its thresholds in real-time.

The risk analyzer 126 evaluates the combined risk score relative to the determined threshold, or thresholds, and analyzes the results of the evaluation relative to the threshold, or thresholds. In examples where the threshold determiner 124 determines a single threshold, the risk analyzer 126 evaluates the combined risk score relative to the determined threshold. Where the generated initial impact score is greater than the determined threshold, the risk analyzer 126 flags the supplier as a high risk, and where the combined risk score is not greater than the determined threshold, the risk analyzer 126 flags the supplier as other than high risk. In examples where the threshold determiner 124 determines more than one threshold, such as two thresholds, the risk analyzer 126 evaluates the combined risk score relative to each of the determined thresholds. Where the combined risk score is greater than the higher determined threshold, the risk analyzer 126 flags the supplier as a high risk. Where the combined risk score is not greater than the higher determined threshold but is greater than the lower determined threshold, the risk analyzer 126 flags the supplier as a medium risk. Where the combined risk score is not greater than the lower determined threshold, the risk analyzer 126 flags the supplier as a low risk.

In examples where the supplier is flagged as a high risk, the questionnaire generator 128 generates a questionnaire to be sent to the supplier. The generated questionnaire may be dynamically updateable, tailored to the risks identified by the risk assessor 118, and used to collect additional information from the supplier as a part of additional due diligence in further analyzing the risk of the supplier. For example, the generated questionnaire includes questions regarding the general cybersecurity posture of the supplier, to include how data is encrypted and stored by the supplier, how privacy-related information is processed by the supplier, how cybersecurity incidents are handled by the supplier, and so forth. The output generator 130 generates an output that includes the combined risk score as a result of the analysis by the risk analyzer 126 identifying the supplier as high, low, or medium risk or with an otherwise identifying risk score, such as a numerical score. In some examples, the generated output further includes one or more of the generated initial impact score, the generated initial likelihood score, the determined one or more thresholds used to analyze the combined risk score, data values and weights for each of the factors used to determine the one or more thresholds, details regarding the supplier engagement, whether a questionnaire was generated and output to the supplier and if so, whether answers or responses were received from the supplier, and potential follow-on actions for the organization to take to document and treat the risk identified. In some examples, the output from the output generator 130 is automatically and dynamically generated. In some examples, the output is presented on the computing device 102, such as on the user interface device 112. In some examples, the output is transmitted to the external device 134 via the network 138. In some examples, the output is structured as supplier risk control effectiveness data that may be used as a downstream input for an enterprise risk quantification system, such as the comprehensive risk analyzer 135 implemented on the external device 134.

The notification generator 131 evaluates the output generated by the output generator 130 relative to notification triggering data 116 to determine whether notifications are to be sent to one or more recipients through an external device 134. The notification triggering data 116 includes, but is not limited to, factors related to which topics are to be used for triggering, thresholds for triggering for each topic, and the destination of the notification. In some examples, topics include, but are not limited to, the type of technology used by the supplier, the privacy or sensitivity of the data used by the supplier, and so forth. In some examples, thresholds include, but are not limited to, whether the services provided by the supplier to the organization include the use of AI, PII data of the organization, the intellectual property of the organization, and so forth. In some examples, destinations for notifications include various teams or groups within the organization, such as an AI governance team, procurement team, privacy governance team, data protection legal team, and so forth. In examples where the notification generator 131 sends notifications to recipients, the notifications may be sent in the form of emails delivered to individuals and teams, push notifications, internal enterprise messaging systems, and so forth.

The feedback receiver 132 receives feedback on the generated output. In some examples, the risk assessor 118 includes an ML or AI model that uses the received feedback from human experts in the form of training data 116 and is updated to continuously improve aspects of the risk assessor 118 including but not limited to the impact score generator 120, the likelihood score generator 122, the combined score generator 123, the threshold determiner 124, the risk analyzer 126, the output generator 130, and the feedback receiver 132 itself. For example, the impact score generator 120 continuously improves its model to generate improved impact score predictions over time, and the likelihood generator 122 continuously improves its model to generate improved likelihood score predictions over time. Because the data 116 is dynamically refreshed, the feedback receiver 132 provides the risk assessor 118 the data needed to continuously improve itself, particularly where ML or AI models are automatically and dynamically re-trained on human expert data.

In some examples, the training data 116 includes details about an organization's relationships with third-party suppliers to include supplier cost, criticality, quality, type of product or service, and whether or not the supplier handles sensitive data about the organization or its personnel. In some examples, the training data 116 further includes ground truth data, such as human expert labels, for highest-risk suppliers, as well as labels for suppliers involved in real-world cybersecurity breaches. The risk assessor 118 is trained using the training data, and the output is an AI or ML model which predicts one or more risk thresholds tailored to an organization's risk priorities. As noted above, because the data 116 is dynamically refreshed, the feedback receiver 132 provides the risk assessor 118 the data needed to continuously improve itself, particularly where ML or AI models are automatically and dynamically re-trained on human expert data.

In some examples, one or more elements of the risk assessor 118 are designed in order to skew toward mitigating, or in some examples completely removing, false negatives. In other words, the ML models of the risk assessor 118 are tuned during training such that a supplier that, in actuality, is a high risk is not flagged as low risk. Conversely, while this may skew toward identifying some suppliers as high risk that, upon further review, are in actuality medium or low risk, such a design accepts the risk of performing additional analysis on some suppliers that otherwise may not have been warranted in order to prevent higher risk suppliers from avoiding such additional analysis.

Furthermore, in some examples, the ML models of the risk assessor 118 are trained using training data that identifies suppliers, various data values associated with the suppliers as described herein, and reported real-world results. For example, the risk assessor 118 is trained on data that identifies a particular type of supplier as having a high impact to an organization and therefore a high risk score due to the amount of money spent on a contract with the supplier, sensitivity of data the supplier receives from the organization, and an anticipated high impact to the organization should the supplier need to be replaced due to a lack of other, similar suppliers to perform the same function at the same scale. Various combinations of data values are used to the train the risk assessor 118 to identify the risk for various types of suppliers.

In some examples, the risk assessor 118 is trained according to the specific organization or type of organization, or team with the organization, which deploys, or is anticipated to deploy, the risk assessor 118 on the computing device 102. For example, a small organization that sells low-risk good and services such as groceries and personal products in a small market is expected to analyze and evaluate risk much differently than a large organization that utilizes software and personal information to market consumer health products or security software. Further, even within an organization, different suppliers are treated very differently depending on the department or group that utilizes the risk assessor 118 to analyze its suppliers. For example, a supplier for a Human Resources (HR) or Legal department will likely have access to PII of employees, which is subject to and necessarily protected by stringent guidelines and regulations, whereas a supply chain provider may only receive a purchase order for a particular amount of a product. As described herein, the risk assessor 118 is trained using training data 116 that identifies these distinctions and accordingly treats different categories of suppliers differently.

The external device 134 is another example of a computing device, separate from and external to the computing device 102. In some examples, the user device 134 includes a mobile computing device or any other portable device. A mobile computing device includes, for example but without limitation, a mobile telephone, laptop, tablet, computing pad, netbook, gaming device, and/or portable media player. The user device 134 can also include less-portable devices such as servers, desktop personal computers, kiosks, or tabletop devices. Additionally, the user device 134 can represent a group of processing units or other computing devices. The server 136, in some examples, is an example of an external storage device, remote data storage device, a data storage in a remote data center, or a cloud storage. In one example the external device 134 is an enterprise risk quantification system, which can use inputs from, and send outputs to, the computing device 102. In another example, the external device 134 is an email server which receives email notifications from the notification generator 131.

In examples where the external device 134 is a comprehensive enterprise risk quantification system, the external device includes a comprehensive risk analyzer 135 that takes, as input, the output(s) received from the risk assessor 118, such as those received from the output generator 130 via the communications interface device 112. The comprehensive risk analyzer 135 uses the output of the risk assessor 118, which is tailored supplier risk data, along with outputs from other risk assessment systems throughout the organization. Examples of other risk assessment systems used throughout the organization may include a cybersecurity risk assessor, a financial risk assessor, a regulatory/compliance risk assessor, an operational risk assessor, and so forth. Accordingly, the risk assessor 118 is designed to fit within a larger ecosystem of risk quantification for systems, suppliers, sites, people, and other risks domains.

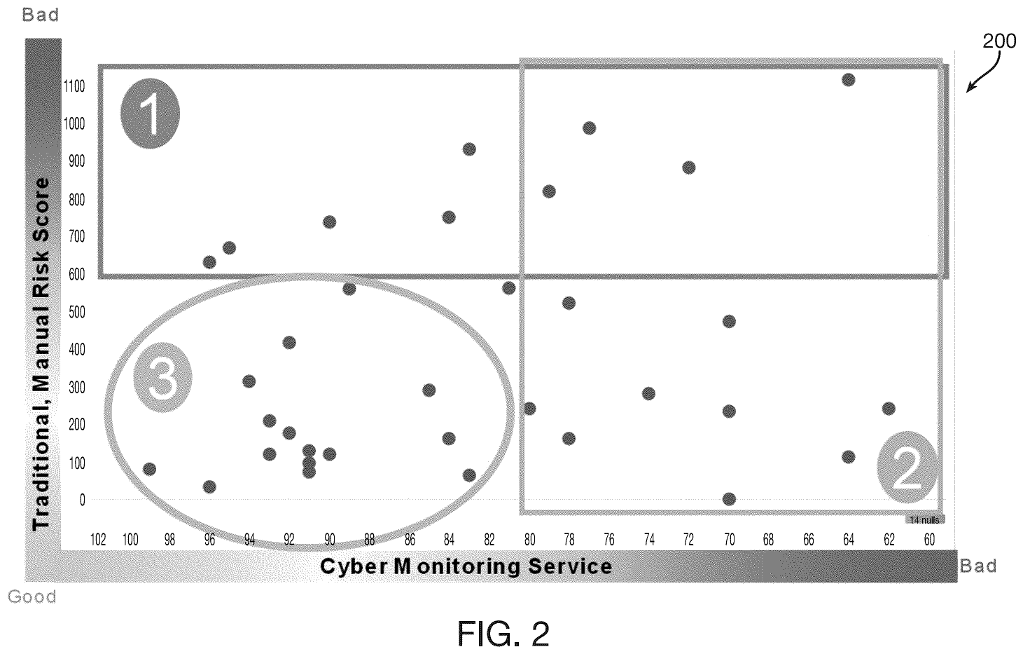

FIG. 2 illustrates a technical problem presented by the current state of existing risk assessment systems. The chart 200 includes a first box (1) illustrating that traditional, manual risk assessment is only approximately 25% effective, as it is performed manually, takes a significant amount of time to complete, and fails to capture significant areas of risk. The chart 200 further includes a second box (2) illustrating existing monitoring services, which capture some risk that is not captured in the first box (1), some risk also captured by the first box (1), but also misses some of the risk that is captured by the first box (1). Each of the first box (1) and the second box (2) fail to capture the risk included in the third box (3) illustrated in the chart 200. In other words, neither the methods illustrated by the first box (1) and the second box (2) alone capture a significant portion of actual risk, illustrating a need for improved risk assessment systems capable of performing risk assessments of technical suppliers at scale which generate new data structures to store and present supplier and organization risk data, reduce the burden of human input or otherwise human interaction from the traditional risk assessment process, and reduce the consumption of computing resources. The examples provided herein provide a technical solution to this inherently technical problem by implementing a streamlined, efficient analysis that, for new suppliers, generates a comprehensive risk profile and, for existing suppliers, identifies updates to the supplier dynamics and the organization dynamics and generates updated risk scores accordingly.

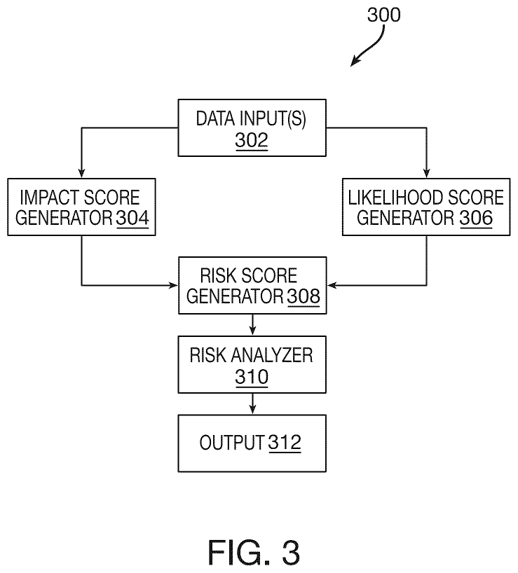

FIG. 3 illustrates a system for generating an output of a risk assessment. The system 300 is presented for illustration only and should not be construed as limiting. In some examples, the system 300 can be implemented by one or more electronic devices described herein, such as the computing device 102.

The system 300 includes one or more data inputs 302. The one or more data inputs 302 stored as data 116 in the data storage device 114 that include, but are not limited to, spending data, i.e., the amount of money provided to the supplier or vendor in exchange for services, a supplier category, supplier quality data associated with the supplier, and a data security classification for the supplier. The data inputs 302 are input into an impact score generator 304 and a likelihood score generator 306. In some examples, the impact score generator 304 is an example of the impact score generator 120 and the likelihood score generator 306 is an example of the likelihood score generator 122. The impact score generator 304 is a predictive ML model that applies to all supplier risk functions that predicts how impactful a supplier is to an organization based on the dynamically available data inputs. The level of impact is the generated impact score. In other words, the impact score is a measure of the level of impact that would be felt to the organization should the supplier suffer a significant adverse event, e.g., be compromised, be non-operational, or have to be replaced. The impact score is quantified by one or more variables, as described herein, such as how much money the organization spends with the supplier, replaceability of the supplier, how many other suppliers can supply the same products, goods, or services, whether or not the supplier processes sensitive data or intellectual property (IP) of the organization, the type of supplier, e.g., supply chain provider, IT/software provider, law firm, HR provider, logistics or packaging company, marketing firm, and so forth. The likelihood score generator 306 is a predictive ML model that applies to all supplier risk functions that predict the likelihood the supplier will be subject to an event that impacts the organization, such as a cyber-attack, a logistical event, bankruptcy, and so forth. The likelihood score is a measure of the likelihood of the event occurring and is quantified through self-attestation and/or through objective proof by one or more variables, as described herein, such as the frequency of which the supplier has had an event occur, the severity of the event, the recency of the event or events, the observable footprint or vulnerabilities (physical or digital) of the supplier, and so forth.

The impact score generated by the impact score generator 304 and the likelihood score generated by the likelihood score generator 306 are provided to a risk score generator 308, which generates a risk score for the supplier. In some examples, the risk score generator 308 is an example of the combined score generator 123. As described herein, the generated risk score is a measure of the overall risk of the supplier based on both the impact the supplier has, or will have, on the organization and the likelihood that the supplier will be subject to an event that impacts the organization. In some examples, the generated risk score is generated using dynamically adjustable weighting of the impact score and the likelihood score. The generated risk score is adjustable in that it can be changed, and is dynamic in that it can automatically adjust based on a trigger of updated or newly available data 116, e.g., the type of supplier, the importance of the supplier for a particular time period, a measure of the quality or comprehensiveness of the data inputs, changes in organizational operation and/or strategy, and so forth.

A risk analyzer 310 analyzes the generated risk score by evaluating the combined risk score relative to the determined threshold, or thresholds, and analyzing the results of the evaluation relative to the threshold, or thresholds. In some examples, the risk analyzer 310 is an example of the risk analyzer 126. The generated risk score is included in an output 310 that includes, in addition to the generated risk score, the determined one or more thresholds used to analyze the generated risk score, data values and weights for each of the factors used to determine the one or more thresholds, and, if a questionnaire was generated to the supplier, the details of the questionnaire responses and their associated comments and auto-generated scores. In some examples, the output 310 is presented on the computing device 102, such as on the user interface device 112. In some examples, the output 310 is transmitted to an external device, such as the external device 134, via the communications interface device 112.

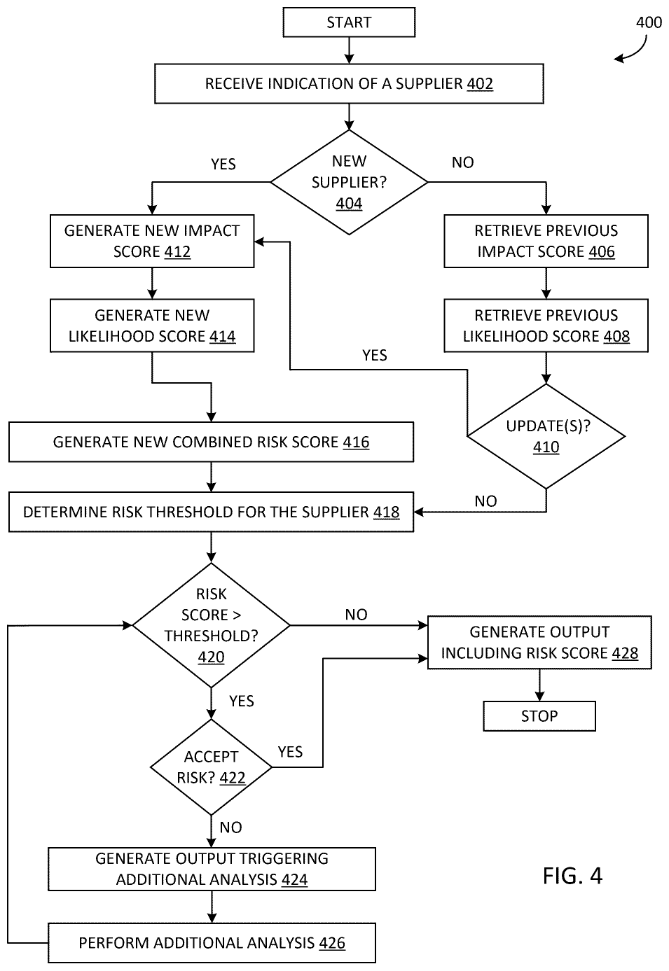

FIG. 4 illustrates an example computer-implemented method of generating an output of a risk assessment. The computer-implemented method 400 is presented for illustration only and should not be construed as limiting. Other examples of the computer-implemented method 400 can be used without departing from the scope of the present disclosure. The computer-implemented method 400 can be implemented by one or more electronic devices described herein, such as the computing device 102.

The method 400 begins by the risk assessor 118 receiving an indication of a supplier in operation 402. The reception of the indication of the supplier triggers a risk analysis that ultimately results in generating a detailed risk assessment and recommendation for the supplier as an output. The indication of the supplier may be received through various mechanisms. For example, the indication may be received from a manual input, based on the supplier or the organizational engagement owner registering through a web or mobile application, or automatically based on the determination that a potential or actual supplier has been identified in the organization's procurement or invoicing systems, respectively, and so forth.

In operation 404, the risk assessor 118 determines whether the identified supplier is a new supplier. A list of existing suppliers is stored as data 116 in the data storage device 114 and/or the server 136 with a unique alphanumeric identifier for the supplier identified in operation 402. In operation 404, the identification of the supplier in question is cross-referenced with the supplier identifiers stored as data 116 to determine whether the supplier is a new supplier. In examples where the supplier is not a new supplier, the method 400 proceeds to operation 406, where the risk assessor 118 retrieves a previously generated impact score for the supplier, and in operation 408 the risk assessor 118 retrieves a previously generated likelihood score for the supplier. The previously generated impact score and likelihood score are each stored as data 116 in the data storage device 114 and/or the server 136 and retrieved based on the supplier not being new, i.e., being an existing supplier. The previously generated impact score and likelihood score are each identified with the identification tag, such as a reference number, name, etc., that identifies the supplier. In operation 410, the risk assessor 118 determines whether additional data received with the indication in operation 402 indicates that the previously generated impact score and/or likelihood score has materially changed since the previous time the data was stored in the data storage device 116 or the server 136. In examples where an update is needed, the method 400 proceeds to operation 412, and in examples where an update is not needed, the method 400 proceeds to operation 418.

In examples where the supplier is identified as new in operation 404 and/or where an update is determined to be needed in operation 410, in operation 412 the risk assessor 118 generates a new, updated impact score for the supplier. For example, the impact score generator 120 generates an initial impact score for the supplier based on multiple weighted variables, including but not limited to data 116 associated with the supplier such as spending data, a supplier category, supplier quality data associated with the supplier, and a data security classification for the supplier as described herein. In operation 414, the risk assessor 118 generates a new likelihood score for the supplier as described herein.

In operation 416, the risk assessor 118 generates a new combined risk score for the supplier based on the generated new impact score and the generated new likelihood score. As described herein, the combined risk score measures the overall risk of the supplier based on both the impact the supplier has, or will have, on the organization and the likelihood that the supplier will be subject to an event that impacts the organization.

In operation 418, the risk assessor 118 determines one or more dynamic risk thresholds for the supplier. For example, the threshold determiner 124 determines one or more thresholds to be used to analyze the risk expressed by the combined risk score. In some examples, the threshold determiner 124 determines a single threshold to be used. In other examples, the threshold determiner 124 determines more than one threshold to be used, such as two thresholds, a higher threshold and a lower threshold. For example, an organization may need multiple risk thresholds to increase the fidelity of risk determinations. The threshold determiner 124 meets this need by identifying and implementing multiple thresholds, and therefore may be tailored to the organization's risk priorities.

In operation 420, the risk assessor 118 evaluates the generated new combined risk score relative to the determined risk threshold and determines whether the generated new combined risk score is greater than the determined risk threshold. In some examples, the determined risk threshold to which the risk score is evaluated against is a lowest threshold of the determined one or more thresholds. In other examples, the determined risk threshold to which the risk score is evaluated against is a highest threshold of the determined one or more thresholds. In examples where the risk score is greater than the threshold, the method 400 proceeds to operation 422. In operation 422, the risk assessor 118 determines whether the risk is acceptable based on data from automated or manual inputs. In examples where the risk is determined to be unacceptable, in operation 424, the risk assessor 118 generates an output, i.e., a first output, that triggers an additional analysis of the supplier. For example, the generated output may trigger a questionnaire to be generated and transmitted to the supplier that gathers additional information regarding the supplier, their processes, internal systems, and so forth.

In operation 426, the risk analyzer 126 performs the additional analysis. For example, the additional analysis performed may include an analysis of the received questionnaire that includes answers to the questions. In some examples, the additional analysis includes updating one or more of the impact score and the likelihood score and generating an updated combined risk score. Following the additional analysis, the method 400 returns to operation 420 and the risk assessor 118 evaluates the updated risk score relative to the threshold.

In examples where the risk score is lower than the threshold, as determined by operation 420, or the risk is score is determined to be acceptable by operation 422, the method 400 proceeds to operation 428 and the risk assessor 118 generates an output, i.e., a second output, that includes at least the generated risk score. For example, the output generator 130 generates the output including the combined risk score as a result of the analysis by the risk analyzer 126 identifying the supplier as high, low, or medium risk. In some examples, the generated output further includes one or more of the generated initial impact score, the generated initial likelihood score, the determined one or more thresholds used to analyze the combined risk score, data values and weights for each of the factors used to determine the one or more thresholds, details regarding whether a questionnaire was generated and output to the supplier, and a recommendation regarding the supplier. In some examples, the recommendation includes recommended approaches to mitigate the risk posed by the supplier, contractual language to be implemented to mitigate the risk posed by the supplier, historical risk and events involving the supplier, and so forth. Following the output being generated in operation 428, the method 400 terminates.

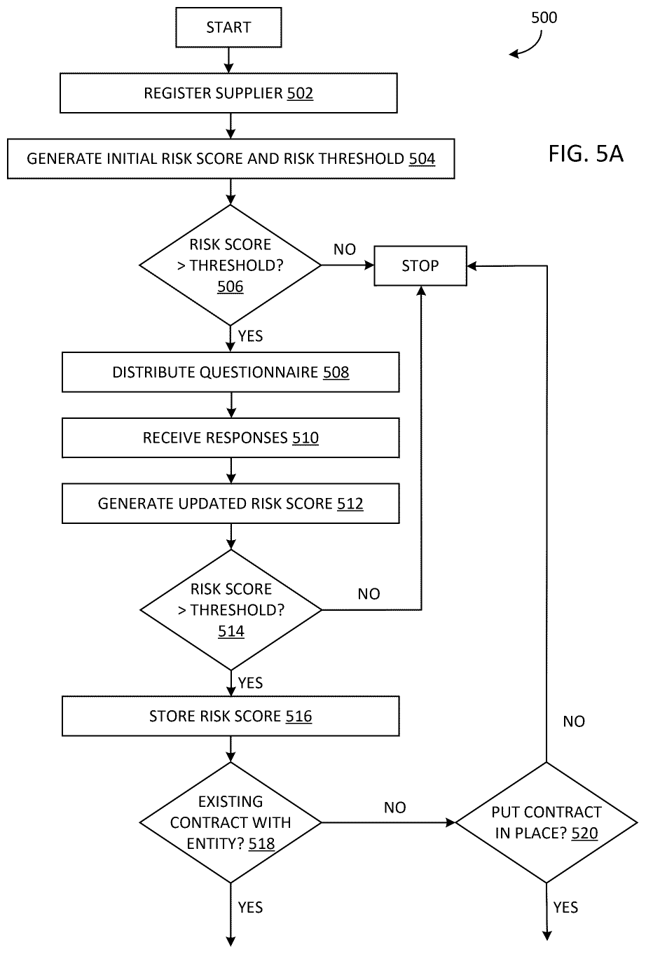

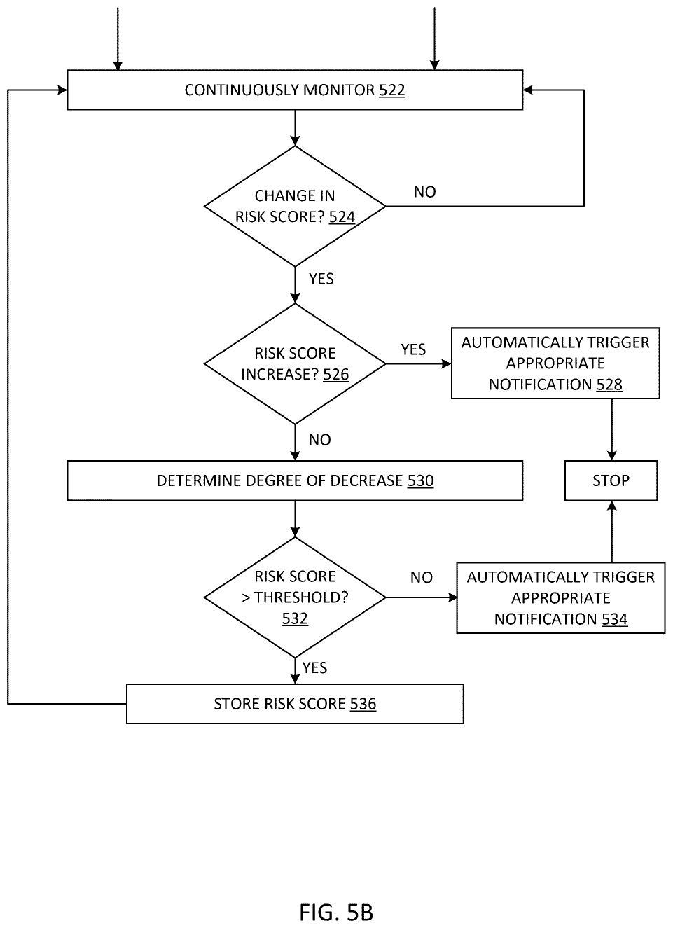

FIGS. 5A-5B illustrate an example computer-implemented method of generating an output of a risk assessment. The computer-implemented method 500 is presented for illustration only and should not be construed as limiting. Other examples of the computer-implemented method 500 can be used without departing from the scope of the present disclosure. The computer-implemented method 500 can be implemented by one or more electronic devices described herein, such as the computing device 102. In some examples, the computer-implemented method 500 is implemented in examples where a supplier registers and is a new supplier, i.e., is not an existing supplier. It should be understood that FIG. 5B is a continuation of FIG. 5A, and FIGS. 5A and 5B collectively illustrate the computer-implemented method 500.

The computer-implemented method 500 begins by the risk assessor 118 registering an entity for a risk assessment system in operation 502. For example, the risk assessor 118 may be an example aspect of a risk assessment system, such as a cybersecurity risk assessment system, a financial risk assessment system, or similar, with which an entity is registered. In some examples, the entity is a supplier, user, company, organization, and so forth.

In operation 504, the impact score generator 120 generates an initial risk score for the entity and the threshold determiner 124 determines a risk threshold for the entity. In some examples, the impact score generator 120 generates the initial risk profile as described in operation 418. For example, in operation 418, the threshold determiner 124 determines one or more risk thresholds to be used as a threshold to analyze the risk expressed by the combined risk score. In some examples, the threshold determiner 124 determines a single threshold to be used. In other examples, the threshold determiner 124 determines more than one threshold to be used, such as two thresholds, a higher threshold and a lower threshold.

In operation 506, the risk assessor 118 evaluates the generated initial risk score relative to the determined risk threshold and determines whether the generated initial risk score is greater than the determined risk threshold as in operation 420. For example, the determined risk threshold to which the risk score is evaluated against is a lowest threshold of the determined one or more thresholds. In other examples, the determined risk threshold to which the risk score is evaluated against is a highest threshold of the determined one or more thresholds. In examples where the risk score is not greater than the threshold, the entity is determined to be of minimal or no risk and the method 500 terminates. In examples where the risk score is greater than the threshold, the method 500 proceeds to operation 508.

In operation 508, the risk assessor 118 distributes a questionnaire to the entity. In some examples, the questionnaire generator 128 generates the questionnaire and the output generator 130 generates an output, including the generated questionnaire, that is distributed, via the communications interface device 112, to an external device associated with the entity. As described herein, the generated questionnaire includes questions regarding the general cybersecurity posture of the entity, including how data is encrypted and stored, how privacy-related information is processed, how cybersecurity incidents are handled, and so forth. In some examples, the external device associated with the entity is the external device 134. In other examples, the external device associated with the entity is an additional external device similar to the external device 134, or the server 136.

In operation 510, the feedback receiver 132 receives responses to the questionnaire from the device associated with the entity via the communications interface device 112. For example, a user of the entity may input responses to the questions of the questionnaire, which are then transmitted to the computing device 102 via the communications interface 112. In operation 512, the combined score generator 123 generates an updated risk score based on the received responses. The responses to the questionnaire provide additional detail regarding the profile of the entity, which may increase or decrease the risk score for the entity.

In operation 514, the risk analyzer 126 evaluates the generated new combined risk score relative to the determined risk threshold and determines whether the generated new combined risk score is greater than the determined risk threshold as in operation 420. In examples where the risk score is not greater than the threshold, the entity is determined to be of an acceptable level of risk and the method 500 terminates. In examples where the risk score is greater than the threshold, the method 500 proceeds to operation 516. In operation 516, the generated new combined risk score is stored, for example as data 116 in the data storage device 114 or on an external device, such as the server 136.

In operation 518, the risk analyzer 126 determines whether an existing contract with the entity is in place. For example, the risk analyzer 126 may determine whether an existing contract, such as a supply agreement, purchase order, and so forth is stored in the data storage device 114 or on the server 136 as data 116. If an existing contract is found, the risk analyzer 126 determines whether the found contract is still in place, such as by determining the termination date of the contract, which may be stored as metadata, and evaluating the termination date relative to the current date. Where the current date is prior to the termination date, the contract is determined to be in force and the computer-implemented method 500 proceeds to operation 522. Where the current date is after the termination date, the risk analyzer 126 determines no existing contract is in place and proceeds to operation 520, where the notification generator 131 generates a notification to an external device, such as the external device 134, that a contract may be needed with the entity. In operation 520, where a contract is not put in place, the computer-implemented method 500 terminates. Where a contract is put in place, the computer-implemented method 500 proceeds to operation 522.

In operation 522, the risk analyzer 126 continuously monitors the entity for the occurrences or events that may affect the risk profile of the entity. For example, the risk analyzer 126 monitors the entity for events including, but not limited to, cybersecurity incidents, data breaches, and so forth. In operation 524, the combined score generator 123 determines whether an event results in a change in risk score. For example, the combined score generator 123 generates an updated combined score and then determines whether the updated combined score is different than, i.e., results in a change from, the previous risk score. Where the risk score is not changed, the method 500 returns to operation 522 and the risk analyzer 126 continues to monitor the entity for occurrences or events that may affect the risk profile of the entity. Where the risk score is changed, the method 500 proceeds to operation 526 where the risk analyzer 126 determines whether the risk score has increased in relation to the previous risk score.

Where the risk score has increased in operation 526, in operation 528 the notification generator 131 generates a corresponding notification as appropriate. In some examples, the appropriate notification is an alert of the increased score indicating a need for manual review. In other examples, the appropriate notification is an alert of the increased score that triggers a questionnaire, or updated questionnaire, to be distributed that, when responded to, provides additional information regarding the event. In some examples, the notification triggers additional steps taken to mitigate risk including, but not limited to, meeting with the entity, continuously monitoring the entity, and so forth. In some examples, the risk score increase results in a termination of the relationship with the entity due to the risk the entity presents. In some examples, the risk score increase results in a trigger of additional considerations to protect the organization deploying the risk assessor 118 due to the relationship with the entity. Following operation 528, the method 500 terminates.

Where the risk score has not increased, in operation 530 the risk analyzer 126 determines a degree of decrease for the risk score. Based on the decrease, in operation 532 the risk analyzer 126 evaluates the generated new combined risk score relative to the determined risk threshold and determines whether the generated new combined risk score is greater than the determined risk threshold as described herein. Where the risk score is not greater than the threshold, the notification generator 131 generates a corresponding notification as appropriate. For example, the appropriate notification may be a notification that the change in risk score is not significant enough to change the risk profile of the entity. In examples where the risk score is greater than the threshold, the method 500 proceeds to operation 536. In operation 536, the generated new combined risk score is stored, for example as data 116 in the data storage device 114 or on an external device, such as the server 136. Following operation 536, the method 500 returns to operation 522 and the risk analyzer 126 continues to continuously monitor the entity for the occurrences or events that may affect the risk profile of the entity.

### Example Operating Environment

FIG. 6 is a block diagram of an example computing device 600 for implementing aspects disclosed herein and is designated generally as computing device 600. Computing device 600 is an example of a suitable computing environment and is not intended to suggest any limitation as to the scope of use or functionality of the examples disclosed herein. Neither should computing device 600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 620 that directly or indirectly couples the following devices: computer-storage memory 602, one or more processors 608, one or more presentation components 610, I/O ports 614, I/O components 616, a power supply 618, and a network component 612. While computing device 600 is depicted as a seemingly single device, multiple computing devices 600 may work together and share the depicted device resources. For example, memory 602 may be distributed across multiple devices, and processor(s) 608 may be housed with different devices.

Bus 620 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 602 may take the form of the computer-storage media references below and operatively provide storage of computer-readable instructions, data structures, program modules and other data for computing device 600. In some examples, memory 602 stores one or more of an operating system, a universal application platform, or other program modules and program data. Memory 602 is thus able to store and access data 604 and instructions 606 that are executable by processor 608 and configured to carry out the various operations disclosed herein.

In some examples, memory 602 includes computer-storage media in the form of volatile and/or nonvolatile memory, removable or non-removable memory, data disks in virtual environments, or a combination thereof. Memory 602 may include any quantity of memory associated with or accessible by computing device 600. Memory 602 may be internal to computing device 600 (as shown in FIG. 6), external to computing device 600, or both. Examples of memory 602 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 600. Additionally, or alternatively, memory 602 may be distributed across multiple computing devices 600, for example, in a virtualized environment in which instruction processing is carried out on multiple computing devices 600. For the purposes of this disclosure, “computer storage media,” “computer-storage memory,” “memory,” and “memory devices” are synonymous terms for computer-storage memory 602, and none of these terms include carrier waves or propagating signaling.

Processor(s) 608 may include any quantity of processing units that read data from various entities, such as memory 602 or I/O components 616 and may include CPUs and/or GPUs. Specifically, processor(s) 608 are programmed to execute computer-executable instructions for implementing aspects of the disclosure. The instructions may be performed by the processor, by multiple processors within computing device 600, or by a processor external to client computing device 600. In some examples, processor(s) 608 are programmed to execute instructions such as those illustrated in the in the accompanying drawings. Moreover, in some examples, processor(s) 608 represent an implementation of analog techniques to perform the operations described herein. For example, the operations may be performed by an analog client computing device 600 and/or a digital client computing device 600. Presentation component(s) 610 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 614 allow computing device 600 to be logically coupled to other devices including I/O components 616, some of which may be built in. Example I/O components 616 include, for example but without limitation, a microphone, joystick, game pad, satellite dish, scanner, printer, wireless device, etc.

Computing device 600 may operate in a networked environment via network component 612 using logical connections to one or more remote computers. In some examples, network component 612 includes a network interface card and/or computer-executable instructions (e.g., a driver) for operating the network interface card. Communication between computing device 600 and other devices may occur using any protocol or mechanism over any wired or wireless connection. In some examples, network component 612 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 612 communicates over wireless communication link 622 and/or a wired communication link 622a to a cloud resource 624 across network 626. Various different examples of communication links 622 and 622a include a wireless connection, a wired connection, and/or a dedicated link, and in some examples, at least a portion is routed through the internet.

Although described in connection with an example computing device 700, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In some examples, a computer-implemented method includes receiving an indication of a supplier; generating an impact score for the supplier; generating a likelihood score for the supplier; generating a combined risk score based on the generated impact score and the generated likelihood score; evaluating the generated combined risk score relative to a dynamic risk threshold; and based on the evaluation, generating an output including the generated combined risk score.

In some examples, a system includes a memory; and a processor coupled to the memory configured to: receive an indication of a supplier; generate an impact score for the supplier; generate a likelihood score for the supplier, the generated likelihood score indicating a likelihood the new supplier will be a victim of one or more of a cyber-attack or an operational failure; generate a combined risk score based on the generated impact score and the generated likelihood score, the generated combined risk score indicating an overall risk of the supplier based on an impact of the supplier and the generated likelihood score; evaluate the generated combined risk score relative to a dynamic risk threshold; and based on the evaluation, generate an output including the generated combined risk score.

In some examples, a computer-readable storage media stores instructions that, when executed by a processor, cause the processor to receive an indication of a supplier; generate an impact score for the supplier; generate a likelihood score for the supplier, the generated likelihood score indicating a likelihood the new supplier will be a victim of one or more of a cyber-attack or an operational failure; generate a combined risk score based on the generated impact score and the generated likelihood score, the generated combined risk score indicating an overall risk of the supplier based on an impact of the supplier and the generated likelihood score; based on the generated combined risk score being greater than a dynamic risk threshold, triggering a questionnaire to be transmitted to the supplier; based on a response received from the supplier in response to the transmitted questionnaire, updating the combined risk score; and based on the updated combined risk score, generating an output including the combined risk score.

Further examples for are described herein.

Various examples further include one or more of the following:
determining the dynamic risk threshold based on one or more of a risk tolerance, a type of supplier, a service being supplied by the supplier, a time of year, a history with the supplier, an availability of replacement suppliers, a type of data to be provided to or received from the supplier, whether a compromise has been identified at the supplier and if so, how recently, and an amount of money to be paid to the supplier for the service being supplied by the supplier;
determining the supplier is an existing supplier for an organization;
retrieving a previously generated impact score and a previously generated likelihood score for the existing supplier;
determining to update the previously generated impact score and the previously generated likelihood score for the existing supplier;
updating the previously generated impact score and the previously generated likelihood score for the existing supplier;
generating an updated combined risk score based on the updated impact score and the updated likelihood score;
evaluating the generated combined risk score relative to the dynamic risk threshold;
based on the evaluation, generating an updated output including the updated combined risk score;
determining not to update the previously generated impact score and the previously generated likelihood score for the existing supplier is not needed;
retrieving a previously generated combined risk score for the existing supplier;
evaluating the previously generated combined risk score relative to the dynamic risk threshold;
based on the evaluation, generating a new output including the previously generated combined risk score;
based on the generated combined risk threshold being lower than the dynamic risk threshold, triggering an additional analysis of the supplier;
based on the additional analysis, performing a second evaluation of the generated combined risk score to the dynamic risk threshold;
generating a questionnaire, the questionnaire including at least one question that, when answered, provides additional information regarding at least one of the impact or likelihood of risk of an event of the supplier,
transmitting the questionnaire to the supplier,
receiving a response from the supplier, the received response including the additional information responding to the at least one question
analyzing the received additional information received from the supplier;
implementing a first machine-learning (ML) model to generate the impact score;
implementing a second ML model to generate the likelihood score;
receiving feedback regarding the generated impact score;
based on the received feedback, updating the first ML model;
receiving feedback regarding the generated likelihood score;
based on the received feedback, updating the second ML model;
wherein the likelihood score is a likelihood the supplier will be a victim of a cyber-attack; and
wherein the likelihood score is a likelihood the supplier will be a victim of an operational failure.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method, comprising:
receiving an indication of a supplier;
generating an impact score for the supplier;
generating a likelihood score for the supplier;
generating a combined risk score based on the generated impact score and the generated likelihood score;
evaluating the generated combined risk score relative to a dynamic risk threshold; and
based on the evaluation, generating an output including the generated combined risk score.

2. The computer-implemented method of claim 1 further comprising:
determining the dynamic risk threshold based on one or more of a risk tolerance, a type of supplier, a service being supplied by the supplier, a time of year, a history with the supplier, an availability of replacement suppliers, a type of data to be provided to or received from the supplier, whether a compromise has been identified at the supplier and if so, how recently, and an amount of money to be paid to the supplier for the service being supplied by the supplier.

3. The computer-implemented method of claim 1 further comprising:
determining the supplier is an existing supplier for an organization; and
retrieving a previously generated impact score and a previously generated likelihood score for the existing supplier.

4. The computer-implemented method of claim 3 further comprising:
determining to update the previously generated impact score and the previously generated likelihood score for the existing supplier;
updating the previously generated impact score and the previously generated likelihood score for the existing supplier;
generating an updated combined risk score based on the updated impact score and the updated likelihood score;
evaluating the generated combined risk score relative to the dynamic risk threshold; and
based on the evaluation, generating an updated output including the updated combined risk score.

5. The computer-implemented method of claim 3 further comprising:
determining not to update the previously generated impact score and the previously generated likelihood score for the existing supplier;
retrieving the previously generated combined risk score for the existing supplier;
evaluating the previously generated combined risk score relative to the dynamic risk threshold; and
based on the evaluation, generating a new output including the previously generated combined risk score.

6. The computer-implemented method of claim 1 further comprising:
based on the generated combined risk threshold being lower than the dynamic risk threshold, triggering an additional analysis of the supplier; and
based on the additional analysis, performing a second evaluation of the generated combined risk score to the dynamic risk threshold.

7. The computer-implemented method of claim 6 wherein the additional analysis comprises:
generating a questionnaire, the questionnaire including at least one question that, when answered, provides additional information regarding at least one of the impact or likelihood of risk of an event of the supplier;
transmitting the questionnaire to the supplier;
receiving a response from the supplier, the received response including the additional information responding to the at least one question; and
analyzing the received additional information received from the supplier.

8. The computer-implemented method of claim 1 further comprising:
implementing a first machine-learning (ML) model to generate the impact score; and
implementing a second ML model to generate the likelihood score.

9. The computer-implemented method of claim 8 further comprising:
receiving feedback regarding the generated impact score; and
based on the received feedback, updating the first ML model.

10. The computer-implemented method of claim 8 further comprising:
receiving feedback regarding the generated likelihood score; and
based on the received feedback, updating the second ML model.

11. The computer-implemented method of claim 1, wherein the likelihood score is a likelihood the supplier will be a victim of a cyber-attack.

12. The computer-implemented method of claim 1, wherein the likelihood score is a likelihood the supplier will be a victim of an operational failure.

13. A system comprising:
a memory; and
a processor coupled to the memory configured to:
receive an indication of a supplier;
generate an impact score for the supplier;
generate a likelihood score for the supplier, the generated likelihood score indicating a likelihood the new supplier will be a victim of one or more of a cyber-attack or an operational failure;
generate a combined risk score based on the generated impact score and the generated likelihood score, the generated combined risk score indicating an overall risk of the supplier based on an impact of the supplier and the generated likelihood score;
evaluate the generated combined risk score relative to a dynamic risk threshold; and
based on the evaluation, generate an output including the generated combined risk score.

14. The system of claim 13 wherein the processor is further configured to:
determine the dynamic risk threshold based on one or more of a risk tolerance, a type of supplier, a service being supplied by the supplier, a time of year, a history with the supplier, an availability of replacement suppliers, a type of data to be provided to or received from the supplier, whether a compromise has been identified at the supplier and if so, how recently, and an amount of money to be paid to the supplier for the service being supplied by the supplier.

15. The system of claim 13 wherein the processor is further configured to:
determine the supplier is an existing supplier for an organization; and
retrieve a previously generated impact score and a previously generated likelihood score for the existing supplier.

16. The system of claim 15 wherein the processor is further configured to:
determine to update the previously generated impact score and the previously generated likelihood score for the existing supplier;
update the previously generated impact score and the previously generated likelihood score for the existing supplier;
generate an updated combined risk score based on the updated impact score and the updated likelihood score;
evaluate the generated combined risk score relative to the dynamic risk threshold; and
based on the evaluation, generate an updated output including the updated combined risk score.

17. The system of claim 15 wherein the processor is further configured to:
determine not to update the previously generated impact score and the previously generated likelihood score for the existing supplier;
retrieve the previously generated combined risk score for the existing supplier;
evaluate the previously generated combined risk score relative to the dynamic risk threshold; and
based on the evaluation, generate a new output including the previously generated combined risk score.

18. One or more non-transitory computer readable media storing instructions that, when executed by a processor, cause the processor to:
receiving an indication of a new supplier;
generating an impact score for the new supplier;
generating a likelihood score for the new supplier, the generated likelihood score indicating a likelihood the new supplier will be a victim of one or more of a cyber-attack or an operational failure;
generating a combined risk score based on the generated impact score and the generated likelihood score, the generated combined risk score indicating an overall risk of the supplier based on an impact of the supplier and the generated likelihood score;
based on the generated combined risk score being greater than a dynamic risk threshold, triggering a questionnaire to be transmitted to the supplier;
based on a response received from the supplier in response to the transmitted questionnaire, updating the combined risk score; and
based on the updated combined risk score, generating an output including the combined risk score.

19. The one or more computer readable media of claim 18 further storing instructions that, when executed by the processor, cause the processor to:
determine the dynamic risk threshold based on one or more of a risk tolerance, a type of supplier, a service being supplied by the supplier, a time of year, a history with the supplier, an availability of replacement suppliers, a type of data to be provided to or received from the supplier, whether a compromise has been identified at the supplier and if so, how recently, and an amount of money to be paid to the supplier for the service being supplied by the supplier.

20. The one or more computer readable media of claim 18 further storing instructions that, when executed by the processor, cause the processor to:
implement a first machine-learning (ML) model to generate the impact score;
receive feedback regarding the generated impact score;
based on the received feedback, update the first ML model;
implement a second ML model to generate the likelihood score;
receive feedback regarding the generated likelihood score; and
based on the received feedback, update the second ML model.
